(19) United States
(12) Patent Application Publication
(10) Pub. No.: US 2026/0211511 A1
(43) Pub. Date: Jul. 23, 2026

(54) METHOD FOR CONTROLLING A PAIR OF SMART GLASSES, APPARATUS, AND SMART GLASSES

(71) Applicant: Robert Bosch GmbH, Stuttgart (DE)

(72) Inventors: Lukas Grinewitschus, Reutlingen (DE); Dominik Neeser, Reutlingen (DE); Rudolf Bichler, Eningen (DE)

(21) Appl. No.: 19/157,941

(22) PCT Filed: Apr. 22, 2024
(86) PCT No.: PCT/EP2024/060929

§ 371 Date: Aug. 19, 2025

(30) Foreign Application Priority Data
May 4, 2023 (DE) 10 2023 204 106.5

(51) Int. Cl. G06F 3/0346; G02B 27/00; G02B 27/01; G06F 1/16

(52) U.S. Cl. CPC G06F 3/0346; G02B 27/0093; G02B 27/017; G06F 1/1694; G02B 2027/0178

(57) ABSTRACT

A method for controlling smart glasses. The method includes a step of reading in a sensor signal of a sensor unit arranged on the smart glasses, wherein the sensor signal represents a change in position of the smart glasses with respect to a defined reference point and, additionally or alternatively, a movement of the smart glasses. In addition, the method includes a step of executing a function rule for controlling a function of the smart glasses using the sensor signal, wherein in the step of executing, the function rule is executed to control a measurement function for measuring an object.

### FIELD

The present invention relates to a method for controlling a pair of smart glasses, an apparatus, and smart glasses. The present invention also includes a computer program.

### BACKGROUND INFORMATION

Smart glasses may comprise various components, such as a screen, a computing unit, sensors, a display/projector, cameras, speakers, microphones, or other components. For example, current glasses may provide the ability to play music or control a smartphone connected to the glasses through inputs to the glasses. Furthermore, there are virtual reality glasses or augmented reality glasses in which a position as well as orientation can be determined in order to adjust a representation in the field of view of a user accordingly.

### SUMMARY

A method for controlling smart glasses, an apparatus that uses this method, smart glasses, and a corresponding computer program are provided. Advantageous developments and improvements of the apparatus disclosed herein are made possible by the measures disclosure herein.

With the method of the present invention presented here, functions of the smart glasses can advantageously be controlled to reduce the energy consumption of the glasses and thus a user can be supported in a particularly advantageous manner in everyday activities.

A method according to the present invention for controlling smart glasses is presented. According to an example embodiment of the present invention, the method comprises a step of reading in a sensor signal of a sensor unit arranged on the smart glasses, wherein the sensor signal represents a change in position of the smart glasses with respect to a defined reference point, and additionally or alternatively, a movement of the smart glasses. In addition, the method comprises a step of executing a function rule for controlling a function of the smart glasses using the sensor signal, wherein in the step of executing, the function rule is executed to control a measurement function for measuring an object.

The smart glasses can also be referred to as glasses for short. For example, the smart glasses can be configured to display different information on a display, for example in one or both lenses. Additionally or alternatively, the smart glasses may be configured as so-called virtual reality glasses or augmented reality glasses and, for example, interactions with other devices connected to the smart glasses, such as a smartphone, may be possible. According to an example embodiment of the present invention, the smart glasses may comprise at least one or multiple sensor units or different sensor types in order to determine the position as well as the orientation of the glasses in space. For example, the sensor types may be accelerometers, rotation rate sensors, and magnetic field sensors. The sensor types may either be installed in separate sensors or in one sensor, for example in an inertial measurement unit (IMU). For example, the sensor types record signals in one, two, or three different dimensions. If a user wears the glasses on their nose, this may be considered a reference point or a starting point, for example. If the glasses are removed or placed on the head, the position and orientation of the glasses may change with respect to the reference point. The change in position may be sensed via various sensors or combinations of the sensors. For example, accelerometers and rotation rate sensors may be utilized to sense the movement of the glasses. For example, the sensors may be mounted in or on the housing of the glasses, for example on one or both sides of the glasses or on the bridge. Moreover, proximity sensors or pressure sensors may be utilized in the temples, the bridge, or the nose pads to detect whether the glasses are being removed. The sensors may generate analog signals, which may be converted into digital signals. Using these sensor signals, a change in position or a movement of the smart glasses may be detected in the method presented here. For example, such movement may be a movement of a head of a person wearing the smart glasses. Thus, it may be determined by means of the sensor signal, for example, whether a tilt or rotation of the head and thus also the smart glasses is performed and additionally or alternatively the person moves through space, for example. Additionally or alternatively, a change in the position of the smart glasses with respect to the person may be detected. For example, a nasal root of a user of the smart glasses may be set as a reference point, that is, if the user wears the glasses on their nose, this may be considered a starting point, for example. When the glasses are removed or placed on the head, the position and orientation of the glasses changes relative to the starting point. Using the sensor signal or in response to a sensed movement or position change of the smart glasses, a function rule is executed in the method presented herein. Thus, advantageously, functions of the smart glasses coordinated with a particular movement and, additionally or alternatively, the position of the smart glasses can be controlled, for example, to put the glasses in a power-saving mode or to start and control a particular application. Advantageously, a position and orientation of the glasses may be determined without the aid of cameras.

Specifically, the user is able to measure distances as well as heights with the glasses according to the present invention, without using a further device. Distances and heights may be determined by triangulation with the help of the information about the position and orientation of the glasses, for example, and advantageously allow the user to measure the environment without the need for further equipment.

According to a further embodiment of the present invention, in the step of executing, an orientation angle of the smart glasses may be determined with respect to the object to be measured using the sensor signal, wherein the object may be measured using the orientation angle. For example, the glasses may be used to measure objects. For example, the height of objects, such as a house, may be measured using the glasses. Alternatively, this method can also be used to determine how many meters certain objects lie above or below the user. For measuring the height, for example, the user can focus on the point whose height difference they want to know, for example, a gable of the house. The orientation angle may result from the focus. The accuracy of the determination of the angle can be increased, for example, by displaying, for example, a target cross or a point in the field of view of the user, with the help of which, for example, the gable of the house can be focused. If the distance as well as the height of the glasses above the ground are known, the height of the house can now be determined. This assumes that the object and the user are on one plane. At greater heights, the height of the glasses above the ground may be neglected by approximation. This type of measuring has the advantage that no further equipment is needed, and objects can thus be measured quickly and efficiently.

Advantageously, one example embodiment of the approach of the present invention presented here involves determining, in the step of executing, the orientation angle of the smart glasses using an acceleration signal from an accelerometer arranged on the smart glasses, wherein the acceleration signal represents a spatial orientation of the smart glasses in the earth's gravitational field. An accelerometer, for example, may be understood to mean a sensor that detects acceleration, preferably in three dimensions, and outputs a corresponding acceleration signal, representing, for example, a time characteristic of the detected acceleration or a current acceleration vector. The accelerometer can, for example, be attached to the temple of the smart glasses. Such an embodiment of the approach presented here allows for a relatively accurate determination of the orientation or the orientation angle of the smart glasses in space using technically simple means.

The orientation angle of the smart glasses may be determined particularly precisely when, in the step of executing, the orientation angle of the smart glasses is determined while the smart glasses are recognized as being in a resting position. Such a resting position can be detected, for example, when the acceleration signal shows that the detected acceleration does not change significantly within a tolerance range. In this way, interference caused by superimposition of acceleration due to movement of the smart glasses, in addition to the acceleration due to the earth's gravitational field, can be minimized.

Furthermore, an example embodiment of the approach of the present invention disclosed herein is possible in which, in the step of executing, the orientation angle is determined as an average of a plurality of successively determined orientation angles, and/or the orientation angle is determined when a plurality of successively determined orientation angles deviate from one another by no more than a tolerance value. Such an embodiment also offers the advantage of a more robust determination of the orientation angle of the smart glasses, since, for example, shaking or movement of the smart glasses during the measurement of the orientation angle or the data used to determine the orientation angle can be compensated for as effectively as possible.

Furthermore, in another example embodiment of the approach of the present invention disclosed herein, the orientation angle may be determined, in the step of executing, using integration of a sensor signal provided by a rotation rate sensor arranged on the smart glasses and read in. Such an embodiment of the approach proposed here offers the advantage of additionally providing reliable data for determining the orientation angle, in order to enable the most precise possible determination of a height and/or a distance to the object.

In addition, the method of the present invention may comprise a step of reading the sensor signal again. In this case, in the step of executing, using the re-read sensor signal, a further orientation angle of the smart glasses may be determined with respect to the object to be measured and/or a distance moved by the smart glasses, and/or a relative change in position of the smart glasses with respect to the object, wherein the object can be measured using the orientation angle and the further orientation angle, the relative change in position, and/or the distance. However, the sensor signal does not necessarily need to be read only at the target point in order to detect the orientation angle. Rather, the sensor signal may be read periodically. For example, the sensor signal may be read to detect the orientation angle at the starting point, then read again to measure the distance traveled and also to detect that the glasses are again nearly stationary, such that a second orientation angle can be detected. For example, in this variant of the measurement, a user may first focus on a gable of the house, the height of which is to be determined, for example. A first position of the user or the starting point of the glasses as well as the orientation angle can be detected. In the next step, the user may move in the direction of the object whose height is to be determined. After the user has traveled a certain distance and reached a second position, the gable portion of the house can be refocused. The further orientation angle as well as the distance or its associated direction vector between the first and the second points can be detected. The height of the house can now be determined from the recorded data. This measurement variant offers the advantage that, in addition to the smart glasses, no additional devices or distance meters are required.

According to another example embodiment of the present invention, in the step of executing, the distance moved by the smart glasses and/or the relative change in position of the smart glasses may be determined using integration of an acceleration profile representing the time characteristic of the acceleration of the smart glasses during a time period that lies between the read and the re-read sensor signal. In this way, an additional function, namely determining the distance or relative positional change, can be realized in such an embodiment using sensor signals that are already available.

According to another example embodiment of the present invention, in the step of executing, a height of the smart glasses above a ground surface and/or a height of the smart glasses relative to the object may be determined in order to measure the object. For example, the height of the smart glasses above a ground surface and/or the height of the smart glasses relative to the object may also be determined by integrating an acceleration profile, now in the vertical direction. Such an embodiment of the approach proposed here provides the possibility of measuring the object very precisely, since not only the orientation angle of the smart glasses is taken into account but also the relative height position from which the corresponding orientation angle was recorded. This enables more accurate measurement of parameters to be made, such that triangulation based on these parameters allows for a more precise measurement of the object.

In addition, according to an example embodiment of the present invention, the step of reading in and/or executing may be started in response to a start signal input on the smart glasses and/or a start signal provided by a mobile device that is coupled or couplable to the smart glasses. For example, such a start signal may be triggered by touching an element of the smart glasses and/or by a voice signal. Alternatively or additionally, the step of reading in and/or executing may also be started by a mobile device, for example a cell phone, of the user of the smart glasses. Such an embodiment of the approach presented here offers the advantage of actively starting a measurement of the object so that a permanent or continuous measurement of different objects during operation of the smart glasses may be avoided. In this way, the user comfort may be increased by avoiding irritation when currently no measurement of an object by the user of the smart glasses is desired.

This method of the present invention may, for example, be implemented in software or hardware or in a mixed form of software and hardware, for example in a control unit.

The present invention disclosed herein provides an apparatus which is designed to carry out, control, or implement the steps of a variant of a method of the present invention presented here, in corresponding units. The object underlying the present invention can also be achieved quickly and efficiently by this embodiment variant of the present invention in the form of an apparatus.

For this purpose, according to an example embodiment of the present invention, the apparatus may comprise at least one computing unit for processing signals or data, at least one memory unit for storing signals or data, at least one interface to a sensor or to an actuator for reading sensor signals from the sensor or for outputting data signals or control signals to the actuator, and/or at least one communication interface for reading or outputting data embedded in a communication protocol. The computing unit can be a signal processor, a microcontroller, or the like, for example, and the memory unit can be a flash memory or a magnetic memory unit. The communication interface may be configured to read in or output data wirelessly and/or by wire, wherein a communication interface capable of reading in or outputting data transmitted by wire may read said data, for example electrically or optically, from a respective data transmission line or output the data to a respective data transmission line.

Here, an apparatus may be understood to be an electrical device that processes sensor signals and, on the basis thereof, outputs control signals and/or data signals. The apparatus may have an interface in the form of hardware and/or software. In the case of a hardware design, the interfaces may, for example, be part of a so-called system ASIC, which contains various functions of the apparatus. However, it is also possible that the interfaces are dedicated integrated circuits or consist at least partly of discrete components. When implemented as software, the interfaces can be software modules that are present, for example, on a microcontroller alongside other software modules.

In addition, smart glasses according to the present invention are presented with a variant of the above-described apparatus and with at least one sensor unit for sensing a change in position of the smart glasses with respect to a defined reference point, and additionally or alternatively, a movement of the smart glasses. With this combination, all the advantages of the above-described method may be optimally implemented.

Also advantageous is a computer program product or computer program with program code that may be stored on a machine-readable carrier or storage medium, e.g., a semiconductor memory, a hard disk memory, or an optical memory and which is used to perform, implement, and/or control the steps of the method of the present invention according to one of the embodiments described above, in particular if the program product or program is executed on a computer or an apparatus.

Embodiment examples of the present invention are shown in the figures and explained in more detail in the following description.

### BRIEF DESCRIPTION OF THE DRAWINGS

FIG. 1A shows a schematic illustration of smart glasses according to an embodiment example of the present invention.

FIG. 1B shows a representation of a coordinate system, which shows an orientation of the glasses of the present invention as well as an angle to be determined relative to a direction of the earth's gravitational field.

FIG. 2 shows a flowchart of a method for controlling smart glasses according to an embodiment example of the present invention.

FIG. 3 shows a schematic illustration of a measurement function controllable by means of smart glasses according to an embodiment example of the present invention.

FIG. 4 shows a diagram of a sensor signal according to an embodiment example of the present invention.

FIG. 5 shows a diagram of a sensor signal according to an embodiment example of the present invention.

FIG. 6 shows a schematic illustration of a measurement function controllable by means of smart glasses according to an embodiment example of the present invention.

FIG. 7 shows a schematic illustration of a measurement function controllable by means of smart glasses according to a further embodiment example of the present invention.

FIG. 8 shows a schematic illustration of the choice of a freely selected path x between the first measurement point and the second measurement point for implementing the measurement of the object.

### DETAILED DESCRIPTION OF EXAMPLE EMBODIMENTS

In the following description of favorable embodiment examples of the present invention, the same or similar reference signs are used for the elements which are shown in the various figures and have a similar effect, and wherein a repeated description of these elements is omitted.

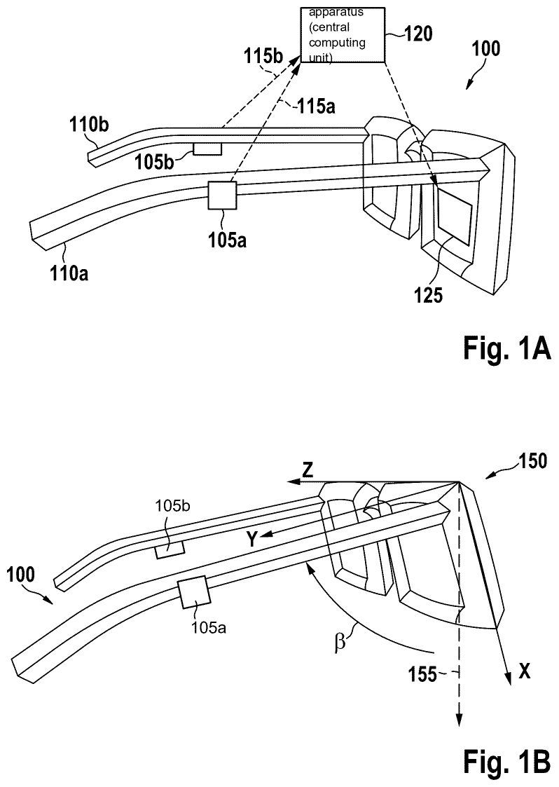

FIG. 1A shows a schematic illustration of smart glasses 100 according to an embodiment example. The smart glasses 100 in this embodiment example include two sensor units 105a, 105b that are arranged merely by way of example on the temples 110a, 110b of the smart glasses 100. In an embodiment example, the sensor units 105a, 105b, which may also be simply referred to as sensors, are configured as accelerometers to sense a movement or a change in position of the smart glasses 100. In embodiment examples, to determine the position or orientation of the glasses in space, the glasses may additionally or alternatively comprise various other sensors and sensor types. Either a portion or all of the sensor types may be utilized. For example, the sensor types may be accelerometers, rotation rate sensors, pressure sensors, as well as magnetic field sensors. The sensors may be mounted in or on the housing of the glasses. In the embodiment example shown here, the sensor units 105a, 105b are mounted merely by way of example on both sides of the glasses or temples 110a, 110b of the glasses 100. In other embodiment examples, it is also possible that the sensors are only mounted on one of the two sides. Optionally, the sensors may also be mounted in or on the bridge.

The sensor units 105a, 105b are configured to provide analog signals that are converted into digital signals, that is, sensor signals 115a, 115b. Here, the sensor signals 115a, 115b represent a change in position of the smart glasses 100 with respect to a defined reference point as well as, by way of example, a movement of the smart glasses. The digital sensor signals 115a, 115b can be read by a apparatus 120. In an embodiment example, the apparatus 120 is a central computing unit that is installed together with the sensor. Alternatively, the computing unit may be arranged in a sensor housing or on an external server, for example as a so-called cloud. It is also possible, however, that only one of the sensors 105a, 105b is present and provides a corresponding sensor signal 115a or 115b, respectively, without impairing the functionality of the glasses.

The apparatus 120 is configured to read the sensor signals 115a, 115b and evaluate them and, using the signals, execute a function rule for controlling a function of the smart glasses. In an embodiment example, the apparatus is configured by way of example in order to enable a measurement of an object. Accordingly, the smart glasses 100 shown here enable the use of different sensor types for determining the position and/or orientation of the glasses in relation to a starting point for the realization of different applications, here specifically the measurement of an object, as will be explained in more detail below.

FIG. 1B shows a representation of a coordinate system 150, which shows an orientation of the glasses 100 as well as an angle R to be determined relative to a direction of the earth's gravitational field 155.

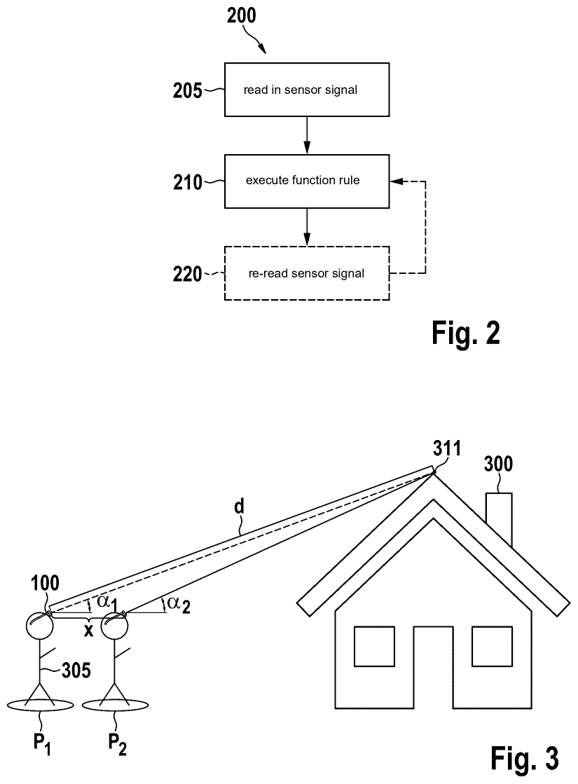

FIG. 2 shows a flowchart of a method 200 for controlling data glasses according to an embodiment example. Method 200 includes a step 205 of reading in a sensor signal of a sensor unit arranged on the smart glasses, wherein the sensor signal represents a change in position of the smart glasses with respect to a defined reference point and, additionally or alternatively, a movement of the smart glasses. In addition, the method 200 comprises a step 210 of executing a function rule for controlling a function of the smart glasses using the sensor signal.

In this step 210 of executing, a special function rule is executed to control a measurement function for measuring an object.

In an embodiment example, if the function rule is executed in the execution step to control a measurement function, then an orientation angle of the smart glasses relative to the object to be measured is determined merely by way of example using the sensor signal. For this purpose, in an embodiment example, in a step 220 of re-reading, the sensor signal is read again, wherein in step 210 of executing, using the re-read sensor signal, a further orientation angle of the smart glasses relative to the object to be measured is determined. Using the orientation angle and the further orientation angle, the object is measured in an embodiment example. Further, the sensor signal between the positions may also be read to determine the distance traveled. With knowledge about the distance traveled, the object may be measured very precisely.

FIG. 3 shows a schematic illustration of a measurement function controllable by means of smart glasses 100 according to an embodiment example. In this application example, the smart glasses 100 can be used for measuring objects. For example, the measurement of the object 300 shown here may be controllable in an executing step as described in FIG. 2.

In the representation shown here, it is shown by way of example how the height of an object 300, which is by way of example a house, may be measured with the help of the glasses. Alternatively, this method may also be used to determine how many meters of certain objects lie above or below the user 305. For the measurement of height, two different approaches can be used by way of example.

In the first variant, the user 305 focuses on the point whose height difference they want to know. In the illustration shown here, the user 305 merely focuses, by way of example, on the gable 311 of the house in a first position P₁. The focus results in the orientation angle α₁. The accuracy of determining the angle α₁ may be increased by displaying, for example, a target cross or a point in the field of view of the user 305, with the help of which, for example, the gable 311 of the house is to be focused. The height of the house may now be determined using two different variants. If the distance d as well as the height of the glasses above the ground is known, the height of the house may be determined. This, of course, assumes that the house and the user 305 are on one plane. For greater heights, the height of the glasses above the ground may be neglected by approximation.

A distance meter is required for determining the distance d. This may be impracticable, which is why a further variant for determining the height is presented here. In the second variant, the user 305 first focuses on the gable 311 of the house. The first position P₁ of the user or the starting point of the smart glasses 100, as well as the orientation angle α₁, are detected. In the next step, the user 305 moves in the direction of the object 300, the height of which is to be determined, i.e., by way of example in the direction of the house. After the user 305 has traveled a distance x and reached a second position P₂, the user 305 refocuses the gable 311 of the house. The further orientation angle α₂ resulting from the refocusing as well as the distance x or its associated direction vector between the first and the second point are detected. The height of the house may now be determined from the detected quantities.

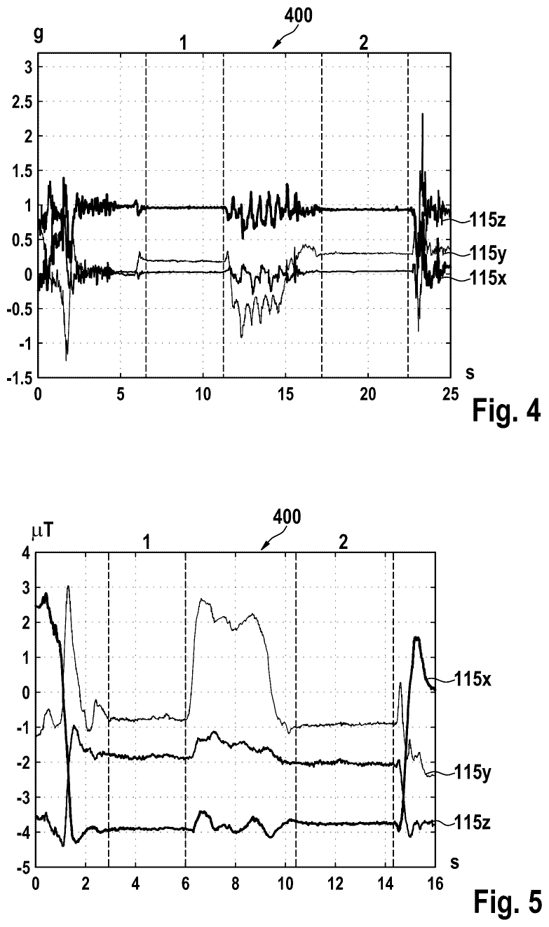

FIG. 4 shows a diagram 400 of a sensor signal 115 according to an embodiment example. The sensor signal 115 shown here is merely by way of example an acceleration g plotted over time s of a signal from an accelerometer of smart glasses, as described in FIGS. 1 and 3, while a user of the smart glasses determines the height of an object. The sensor signal 115 is shown three times, by way of example, to represent the signal as both a sensor signal 115x along an x-axis of the diagram 400, and as a sensor signal 115y along a y-axis and as a sensor signal 115z along a z-axis of the diagram 400.

In the diagram 400 shown here, two areas with numbers 1 and 2 are highlighted. The two areas correspond to the two positions of the stick figure from FIG. 3, wherein the area 1 corresponds to a time interval of approximately 6.5 to 11 seconds and the area 2 corresponds to a time interval of approximately 17 to 23 seconds. In the area between the highlighted areas, the user has approached the object resulting in larger deflections in the representation of the sensor signal 115. In areas 1 and 2, on the other hand, the object to be measured is aimed at and the signal remains relatively constant compared to the movements before and after the highlighted areas. As can be seen in this representation, the values of the acceleration signal 115 in areas 1 and 2 differ. Thus, by way of example, the sensor signal 115y along the y-axis in area 1 has by way of example an acceleration of 0.2 and in area 2 by way of example an acceleration of 0.3. Different angles may thus be determined from the values of the acceleration signal.

FIG. 5 shows a diagram 400 of a sensor signal 115 according to an embodiment example. The sensor signal 115 shown here is merely an example of a magnetic flux density μT plotted over time s of a signal of a magnetic field sensor of smart glasses as described in FIGS. 1 and 3, while a user of the smart glasses determines the height of an object. The sensor signal 115 is shown three times, by way of example, to represent the signal as both a sensor signal 115x along an x-axis of the diagram 500, and as a sensor signal 115y along a y-axis and as a sensor signal 115z along a z-axis of the diagram 500.

In addition to acceleration signals as described in FIG. 4, signals from a magnetic field sensor may also be used. In the representation shown here, the signals from a magnetic field sensor are plotted over time as the user measures the height of an object. Two phases, numbered 1 and 2, are highlighted, wherein phase 1 corresponds to a time interval of approximately 3 to 6 seconds, and phase 2 corresponds to a time interval of approximately 10.5 to 14.5 seconds. The two phases correspond to the two positions of the stick figure in FIG. 3. In the two phases, the signals from the magnetic field sensor are detected as the user focuses on the object whose height is to be determined. To improve the measurement, for example, the signals may be averaged over the duration of the phases. From the determined values of the magnetic flux density, the orientation of the head may be inferred and thus the orientation angle may be determined.

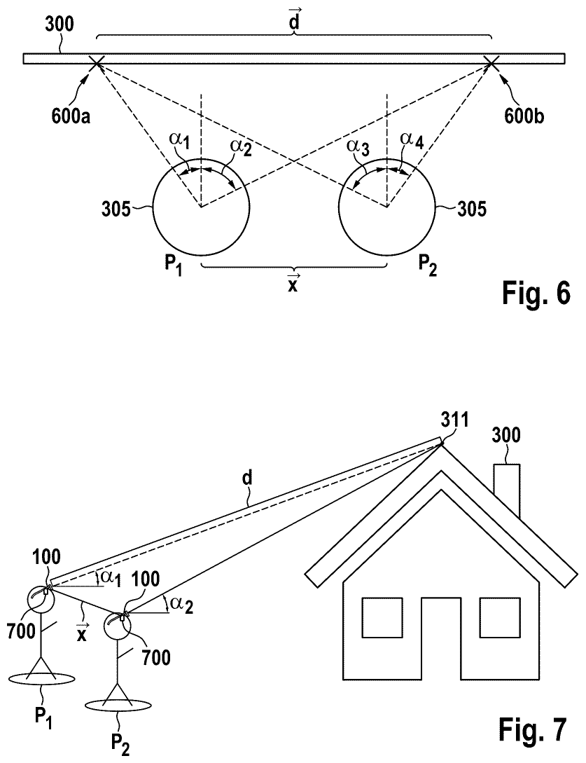

FIG. 6 shows a schematic illustration of a measurement function controllable by means of smart glasses according to an embodiment example. For example, the measurement of the object 300 shown here may be controllable in a step of executing as described in FIG. 2. The object 300 in this embodiment example is a wall.

In addition to the height of an object 300, a horizontal distance may also be determined on a wall, for example, between two drill holes 600a, 600b. Drill holes 600a, 600b are marked by a cross in the image shown here. The method illustrated in this figure may be used to measure any distances that may have other orientations in addition to horizontal ones. In the illustration shown here, a top view can be seen showing two positions P₁, P₂ of a user 305. The user 305 is shown as a circle. First, the user 305 stands at the first position P₁ and focuses once on the left cross, i.e., the first drill hole 600a, and on the right cross, i.e., the second drill hole 600b. Thereafter, the user 305 moves to the second position P₂. At the second position P₂ the user 305 refocuses on the left and on the right cross. Using the angles α₁, α₂, α₃, α₄, and the vector x\vec{ }, the vector d\vec{ } or the horizontal distance d between drill holes 600a, 600b can be determined.

In addition to the above statements, it can be noted here that the approach presented here allows for improved measurement of an object in which the user of the smart glasses 100 does not need to walk directly towards the object to be measured, but instead can choose any path. A measurement function for measuring an object may be realized, for example, as follows. First, the user starts the measurement function by an input. This can be done, for example, by tapping on the glasses. Alternatively, the measurement function may also be triggered, for example, by a cell phone or smartphone that is connected to the glasses or can be connected.

For the measurement function for measuring an object, two angles as well as the distance between the measurement points should be determined. For example, the angles may be determined as described for FIG. 3, wherein the coordinate system shown in FIG. 1B is used. Thus, in FIG. 1B, the reference coordinate system 150 is shown in addition to the glasses. For example, the y-axis is defined along the temples of the glasses 100. The angle to be determined is preferably that between the y-axis and the gravitational vector. The gravitational vector 155 is the vector that points toward the earth's center and thus depicts the earth's gravitational field. The gravitational vector is drawn as a dashed arrow in FIG. 1B. When the user is at rest and does not move, the sum of accelerations measured in the direction of the three axes x, y, and z results in a value of 1 g, or 9.81 m/s². This fact can be used, for example, to detect whether the user is not moving and a measurement can be performed. If

$$\vert \vec{u} \vert \leq 1 g + ε , \qquad ( 1 )$$

a measurement of the angle may be performed, wherein

$$\vec{u} = [ \begin{matrix}x \\ y \\ z\end{matrix} ] \qquad ( 2 )$$

The expression |u\vec{ }| corresponds to the L2 norm or Euclidean norm. The parameter ε determines the tolerance limit up to which a measurement of the angle α₁ or α₂ is carried out. The angles to be determined α₁ and α₂ respectively correspond to the included angle between a vector aligned along the y-axis and the gravitational vector. The included angle between the two vectors a\vec{ } and b\vec{ } may generally be determined with the scalar product

$$γ = {cos}^{- 1} ( \frac{\vec{a} \cdot \vec{b}}{\vert \vec{a} \vert \cdot \vert \vec{b} \vert} ) \qquad ( 3 )$$

To determine the angle β in FIG. 1B, the following expression may be used.

$${β}_{n} = {cos}^{- 1} ( \frac{[ \begin{matrix}0 \\ {y}_{n} \\ 0\end{matrix} ] \cdot {\vec{u}}_{n}}{\vert [ \begin{matrix}0 \\ {y}_{n} \\ 0\end{matrix} ] \vert \cdot \vert {\vec{u}}_{n} \vert} ) , n ∈ \{ 1 , 2 \} \qquad ( 4 )$$

The angle αₙ, n∈{1,2} then corresponds to

$${α}_{n} = 90 ° - {β}_{n} , n ∈ \{ 1 , 2 \} . \qquad ( 5 )$$

In order to increase the accuracy of the measurement of angles α₁ and α₂, respectively, the measurement of angles α₁ and α₂, respectively, can be carried out multiple times and the measured angles α₁ and α₂ averaged over the measurements, respectively. It is further possible to perform the measurement until the further measurements of angles α₁ and α₂ only result in deviations below a certain limit value or below a tolerance range. Angles α₁ and α₂ respectively may optionally also be determined via a rotation rate sensor. When using a rotation rate sensor, the rotation rate is then integrated, for example. It is further possible to use a combination of signals from an accelerometer and a rotation rate sensor, preferably in the form of an IMU, for measuring angles α₁ and α₂, respectively. Furthermore, a magnetic field sensor may be used to improve the measurement result.

Between the measurements of angles α₁ and α₂ respectively, the distance between the measurement points should be determined. Preferably, the two measurement points are at the same height, as shown in FIG. 3.

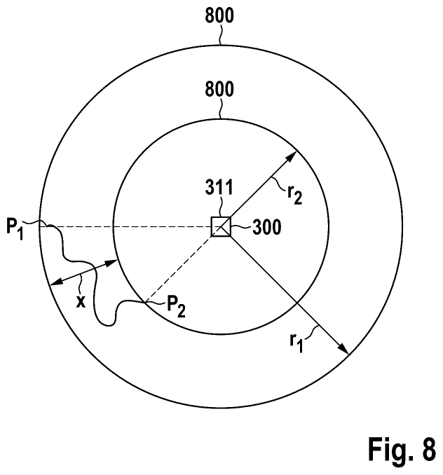

FIG. 7 shows a schematic representation of a measurement function controllable by means of smart glasses according to a further embodiment example, in which the two measurement points P₁ and P₂ (or the corresponding positions P₁ or P₂) of the smart glasses 100 are at different heights. In this case, the height of the glasses 100 above the ground and/or relative to the position of the object 300 may be determined, for example, with the aid of a pressure sensor 700. From the detection of the path x\vec{ }, the height difference between the two measurement points P₁ and P₂ can also be inferred. This can be done, for example, via a method in which, among other things, a double integration via the signal of the accelerometer on the smart glasses 100 is carried out in order to determine the distance traveled x\vec{ } between the two measurement points P₁ and P₂.

The second measurement point P₁ or P₂ should be selected by the user such that the second measurement point P₂ lies on a line between the first measurement point P₁ and the object 300 to be measured. Alternatively, if the overall orientation of the glasses 100 is also sensed to determine in which direction the user is looking, the user may approach or move away from the object 300 being measured by a freely selected path x\vec{ }. From the overall orientation of the glasses 100 at the first measurement point P₁ and at the second measurement point P₂, the distance x required for the measurement may be determined.

FIG. 8 shows a schematic illustration of the choice of a freely chosen path between the first measurement point P₁ and the second measurement point P₂ for implementing the measurement of the object 300. FIG. 8 shows a method by which the distance x required for the measurement of an object 300 according to FIG. 7 (or also according to FIG. 3) can be determined. By determining the orientation of the glasses 100 at the two measurement points P₁ and P₂ in FIG. 8, the intersection of the two dashed lines may be determined in FIG. 8. The intersection of the two dashed lines is located at the location 311 where the respective point to be measured of the object 300 to be measured is situated. From the intersection point, as well as the orientations of the glasses 100 at the two measurement points P₁ and P₂, as well as knowledge of either the path shown in FIG. 8 or the positions of the measurement points P1 and P2, the circles 800 shown in FIG. 8 as well as their radii r₁ and r₂, respectively, can be determined. The difference between the radii ᵣ₁ and r₂ respectively corresponds to the distance x sought from FIG. 3 and FIG. 8. If the height of the measurement points P₁ or P₂ above the ground is also captured, x is not a scalar, but rather the vector x\vec{ }.

If an embodiment example comprises an “and/or” conjunction between a first feature and a second feature, this is to be read to mean that the embodiment example comprises both the first feature and the second feature according to one embodiment, and either only the first feature or only the second feature according to another embodiment.

1-14. (canceled)

15. A method for controlling smart glasses, the method comprising the following steps:
reading a sensor signal of a sensor unit arranged on the smart glasses, the sensor signal representing a change in position of the smart glasses with respect to a defined reference point and/or a movement of the smart glasses; and
executing a function rule for controlling a function of the smart glasses using the sensor signal, wherein in the step of executing, the function rule is executed to control a measurement function for measuring an object.

16. The method according to claim 15, wherein, in the step of executing using the sensor signal, an orientation angle of the smart glasses is determined with respect to the object to be measured, wherein the object is measured using the orientation angle.

17. The method according to claim 16, wherein in the step of executing, the orientation angle of the smart glasses is determined using an acceleration signal of an accelerometer arranged on the smart glasses, the acceleration signal representing a spatial orientation of the smart glasses in the Earth's gravitational field.

18. The method according to claim 16, wherein in the step of executing, the orientation angle of the smart glasses is determined when the smart glasses are recognized as being in a resting position.

19. The method according to claim 16, wherein: (i) in the step of executing, the orientation angle is determined as the average of a plurality of successively determined orientation angles, and/or (ii) the orientation angle is determined when a plurality of successively determined orientation angles deviate from one another by no more than a tolerance value.

20. The method according to claim 16, wherein in the step of executing, the orientation angle is determined using integration of a sensor signal supplied by a rotation rate sensor arranged on the smart glasses and read in.

21. The method according to claim 16, further comprising:
re-reading the sensor signal, wherein in the step of executing, a further orientation angle of the smart glasses with respect to the object to be measured and/or a distance that the smart glasses have moved and/or a relative change in position of the smart glasses relative to the object is determined using the re-read sensor signal, wherein the object is measured using the orientation angle and the further orientation angle, and/or the relative change in position, and/or the distance.

22. The method according to claim 21, wherein in the step of executing, the distance that the smart glasses have moved, and/or the relative change in position of the smart glasses relative to the object, is determined using an integration of an acceleration profile, which represents a time characteristic of an acceleration of the smart glasses during a time period between the read sensor signal and the re-read sensor signal.

23. The method according to claim 15, wherein in the step of executing, a height of the smart glasses above ground and/or a height of the smart glasses relative to the object is determined to measure the object.

24. The method according to claim 15, wherein the step of reading in and/or the step of executing is started in response to: (i) a start signal input on the smart glasses and/or (ii) a start signal provided via a mobile device coupled or couplable with the smart glasses.

25. An apparatus configured to execute and/or control steps of method for controlling smart glasses, the method comprising the following steps:
reading a sensor signal of a sensor unit arranged on the smart glasses, the sensor signal representing a change in position of the smart glasses with respect to a defined reference point and/or a movement of the smart glasses; and
executing a function rule for controlling a function of the smart glasses using the sensor signal, wherein in the step of executing, the function rule is executed to control a measurement function for measuring an object.

26. Smart glasses, comprising:
an apparatus; and
at least one sensor unit configured to detect a change in position of the smart glasses with respect to a defined reference point and/or a movement of the smart glasses, the sensor unit being arranged on the smart glasses;
wherein the apparatus is configured to execute and/or control steps of method for controlling smart glasses, the method comprising the following steps:
reading a sensor signal of the sensor unit, the sensor signal representing the change in position of the smart glasses with respect to the defined reference point and/or the movement of the smart glasses; and
executing a function rule for controlling a function of the smart glasses using the sensor signal, wherein in the step of executing, the function rule is executed to control a measurement function for measuring an object.

27. A non-transitory machine-readable storage medium on which is stored a computer program for controlling smart glasses, the computer program, when executed by a computer, causing the computer to perform the following steps:
reading a sensor signal of a sensor unit arranged on the smart glasses, the sensor signal representing a change in position of the smart glasses with respect to a defined reference point and/or a movement of the smart glasses; and
executing a function rule for controlling a function of the smart glasses using the sensor signal, wherein in the step of executing, the function rule is executed to control a measurement function for measuring an object.
